(19) United States
(12) Patent Application Publication
(10) Pub. No.: US 2020/0187657 A1
(43) Pub. Date: Jun. 18, 2020

(54) Outdoor Chair Assembly and Method of Making Same

(71) Applicant: OW Lee Co., Ontario, CA (US)

(72) Inventors: Paul Rogers, Rancho Cucamonga, CA (US); Rafael Arteaga, Moreno Valley, CA (US)

(73) Assignee: OW Lee Co., Ontario, CA (US)

(21) Appl. No.: 16/222,639

(22) Filed: Dec. 17, 2018

(51) Int. Cl. A47C 5/06; A47C 1/14; F16B 1/00

(52) U.S. Cl. CPC A47C 5/06; F16B 2001/0028; F16B 1/00; A47C 1/14

(57) ABSTRACT

A chair assembly has a supporting frame and a separate seat and back section. The supporting frame is made of metal and has four legs and at least two horizontal side bars. The seat and back section has a seat portion, a back portion, a seat sock fitted over the seat portion, and a back sock fitted over the back portion. Each sock has a fabric material formed into a sock-like configuration having an upper layer and a lower layer, with three sides being sewn or stitched together, and having one open side, and having a Velcro™ lip along the open side. Each side bar of the seat portion is connected to a separate horizontal side bar of the supporting frame.

### BACKGROUND OF THE INVENTION

### 1. Field of the Invention

The present invention generally relates to outdoor patio furniture, and more particularly, to a wrought aluminum chair assembly and a method for making the chair assembly.

### 2. Description of the Prior Art

Outdoor patio furniture is now found in many homes where people have larger back yards and patios where they can entertain or simply enjoy good weather in the yard. There are many types of outdoor furniture, but all of these types of outdoor furniture need to be portable, durable, and low maintenance. Specifically, the furniture item needs to be heavy enough to withstand winds and weather, yet light enough to be moved around conveniently. In addition, because the furniture is outdoors, it is preferable that little work be needed to maintain the furniture in good condition. Finally, the furniture items need to be durable to withstand the outdoor environment.

Wrought aluminum chairs have been one type of popular outdoor furniture item. These chairs typically have an aluminum or wrought aluminum frame that supports or holds a seat and back portion. The seat and back portions of these chairs are usually made from a durable fabric. These chairs are typically provided with the seat and back portion non-removably secured to the frame. Unfortunately, when the fabric material is torn or otherwise requires changing, the entire chair needs to be replaced as the seat and back portion cannot be removed from the frame. This can be expensive and wasteful as the frame is usually still in good condition and can be re-used, while the entire chair itself can be rather expensive to replace as a whole.

Thus, there remains a need for an outdoor aluminum chair assembly that has a seat and back portion that can be replaced while retaining the frame.

### SUMMARY OF THE DISCLOSURE

It is an object of the present invention to provide an outdoor chair assembly where the seat and back section is separable from the supporting frame.

It is another object of the present invention to provide a method for making an outdoor chair assembly where the seat and back section is separable from the supporting frame.

In order to accomplish the objects of the present invention, a chair assembly is provided having a supporting frame and a seat and back section. The supporting frame is made of metal and has four legs and at least two horizontal side bars. The seat and back section has a seat portion and a back portion, the seat portion having a surrounding frame that defines a seat, and the back portion having a surrounding frame that defines a back rest, with the surrounding frame of the seat portion having at least two side bars. The seat and back section also has a seat sock and a back sock, each sock having a fabric material formed into a sock-like configuration having an upper layer and a lower layer, with three sides being sewn or stitched together, and having one open side, and having a Velcro™ lip along the open side. The back portion is received inside the back sock through the one open side of the back sock, and the seat portion is received inside the seat sock through the one open side of the seat sock. Each side bar of the seat portion is connected to a separate horizontal side bar of the supporting frame.

### BRIEF DESCRIPTION OF THE DRAWINGS

FIG. 1 is a perspective view showing a chair assembly according to one embodiment of the present invention.

FIG. 2 is an exploded front perspective view of the chair assembly of FIG. 1.

FIG. 3 is an exploded rear perspective view of the chair assembly of FIG. 1.

FIG. 4 is an exploded view illustrating how the seat sock and back sock are fitted over the seat and back frame.

FIGS. 5 and 6 illustrate a pneumatic spreading machine that is used to stretch a seat sock so that the seat portion of the frame can be inserted into the seat sock.

FIG. 7 illustrates how the Velcro™ lip of the seat and back socks are folded.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

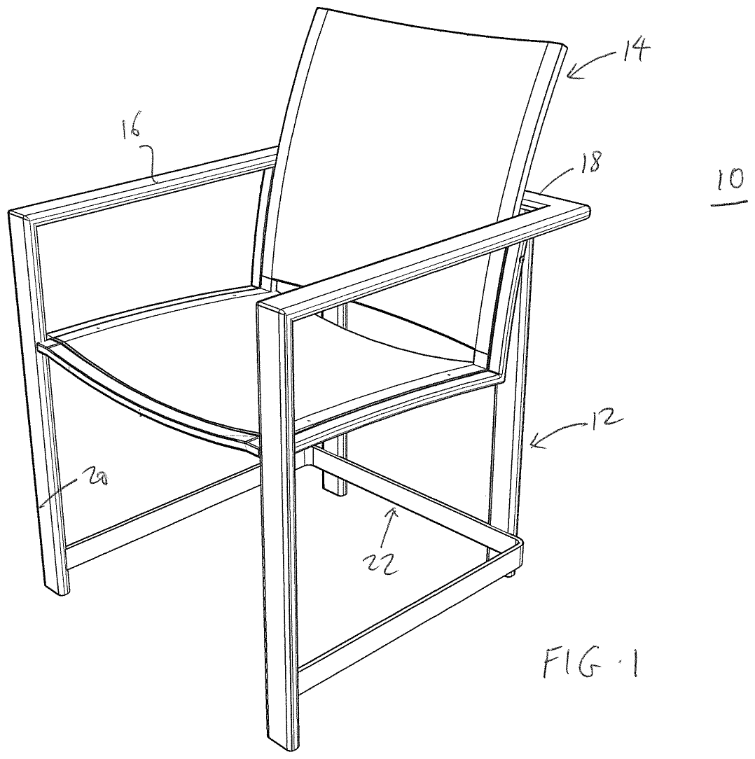

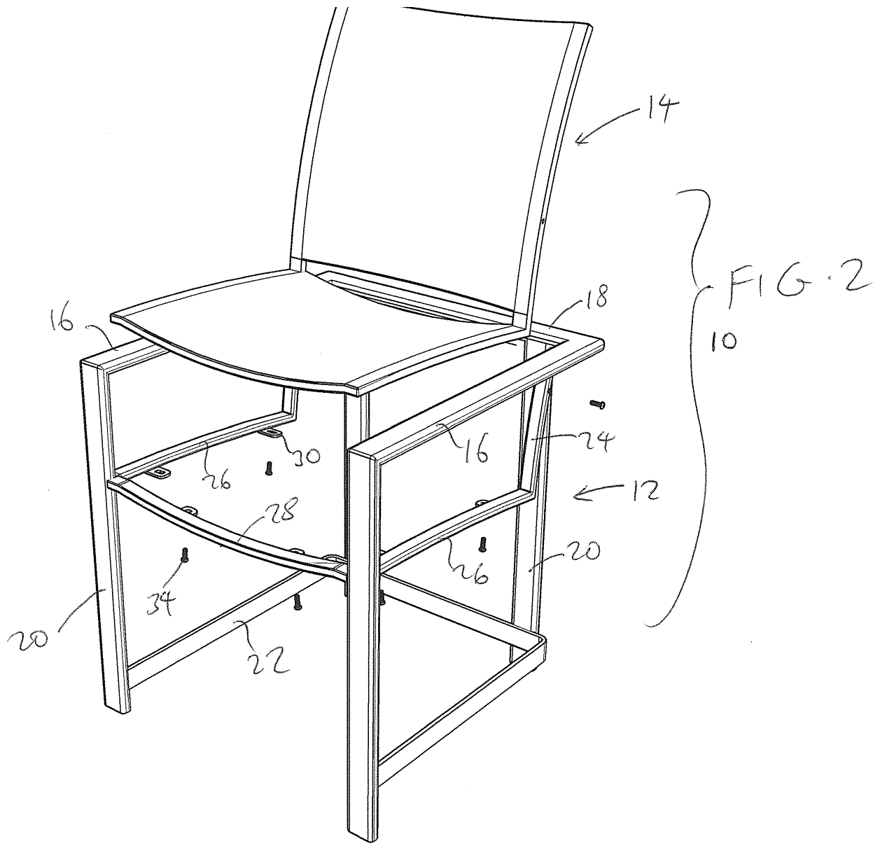

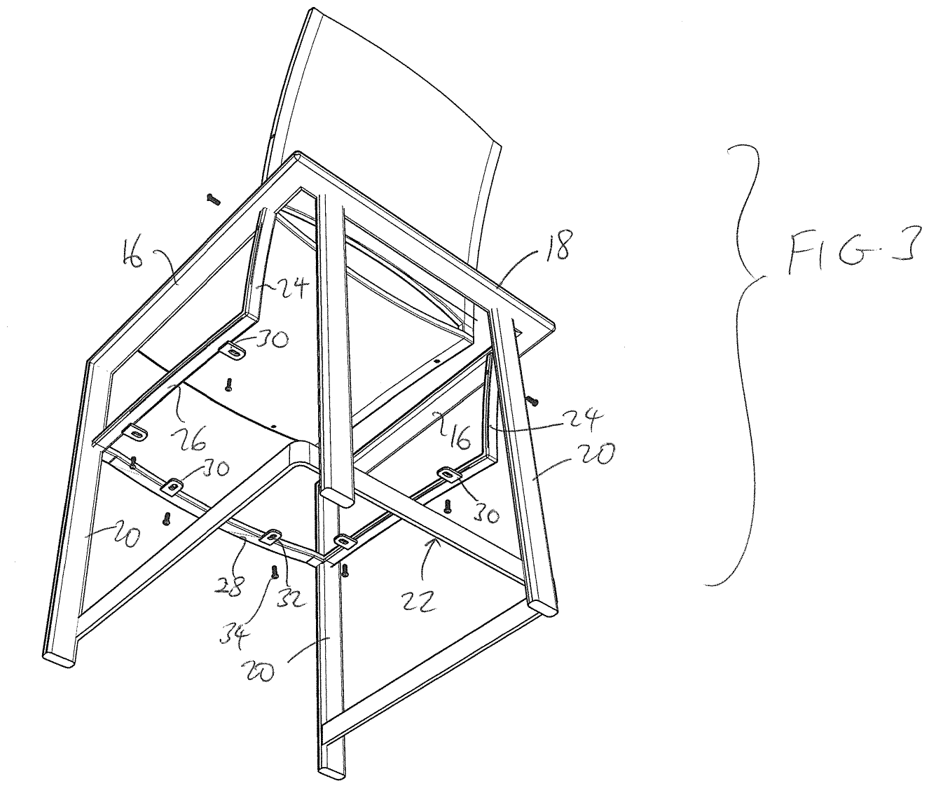

Referring to FIGS. 1-3, a wrought aluminum chair assembly 10 according to the present invention has a supporting frame 12 and a seat and back section 14.

The supporting frame 12 can have an upper U-shaped section that has two arms 16 and a rear border 18. Two front legs 20 extend vertically downwardly from the front end of each arm 16, and two rear legs 20 extend vertically downwardly from opposing ends of the rear border 18. A lower U-shaped section 22 can be provided adjacent the lower ends of the leg 20, and connected to each of the legs 20, to provide stability to the supporting frame 12. One angled support arm 24 extends downwardly from the rear end of each arm 16 for a specific distance, and then transitions into a generally horizontal side bar 26 that extends forwardly to a front end which is connected to the rear surface of a front leg 20. An optional concave front bar 28 can extend across the front between the two front legs 20. A plurality of connectors 30 can be provided in spaced-apart manner along the side bars 26 and the front bar 28. Each connector 30 can be a flat tongue connected to the underside of the bars 26, 28, and having an opening 32 for receiving a bolt 34. The entire supporting frame 12 can be made of a metal, such as aluminum or wrought aluminum, that is durable and rust-resistant.

Referring to FIGS. 1-4, the seat and back portion 14 has a seat and back frame 40 that includes a seat portion 42 and a back portion 44. The seat portion 42 has four bars forming a surrounding frame configured into a square or rectangular configuration to define a seat for an adult, with front and rear bars 46 and 48, respectively, that are slightly curved to form a slight concave configuration. The front and rear bars 46 and 48 are connected by two horizontal and straight side bars 50. The back portion 44 also has four bars forming a surrounding frame configured into a square or rectangular configuration that define a back rest, with the two side bars 52 being slightly arched or curved backwardly. The two side bars 52 are connected by a bottom bar 54 and an upper bar 56. The entire seat and back frame 40 can be made from the same material as the supporting frame 12.

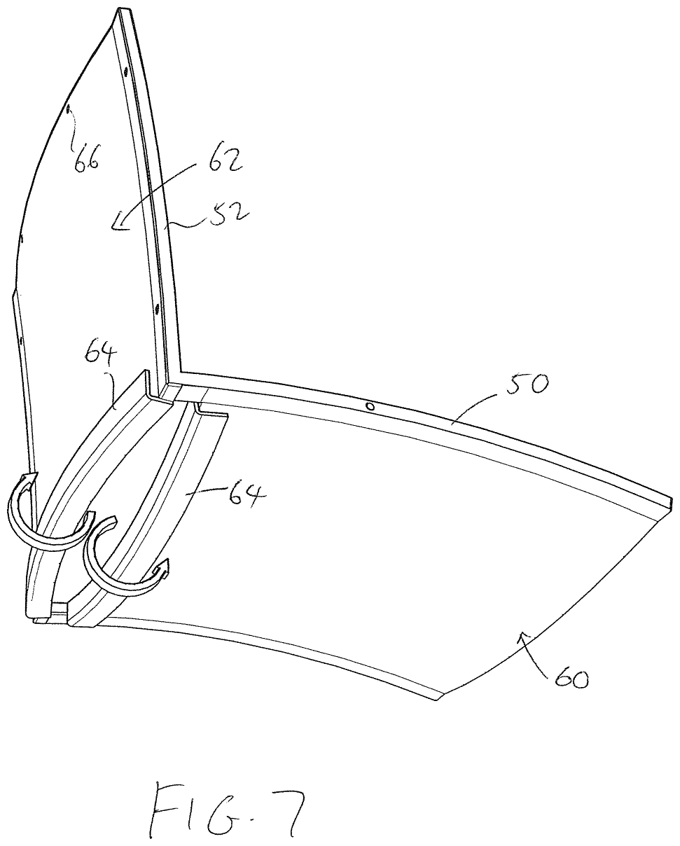

A seat sock 60 can be fitted over the seat portion 42, and a back sock 62 can be fitted over the back portion 44. Each sock 60, 62 can be made, such as by knitting a fabric material 68, into a sock-like configuration having an upper layer and a lower layer, with three sides being sewn or stitched together, and leaving one side 58 open to form a sock. A Velcro™ lip 64 can be sewn along the edge of the open side 58, which can be formed by providing a fabric lip and a Velcro™ strip sewn on the lip. The fabric material 68 can be made from ultraviolet-enhanced polypropylene and co-polymer fibers to give the seat and the back a more comfortable and elastic feel than traditional PVC sling products. The fabric material 68 should have a tensile strength that is sufficient to hold an average adult's weight. The knitting process is what allows this material to be shaped into a “sock” without seams. In addition, while knitting, connector holes 66 (see FIG. 7) can be formed in the fabric material 68, with these holes 66 adapted to be aligned with the openings 32 of the connectors 30 positioned along the bars 26, 28 so that bolts 34 can extend through to openings 32 of the bars 26, 28 that the socks 60, 62 go on.

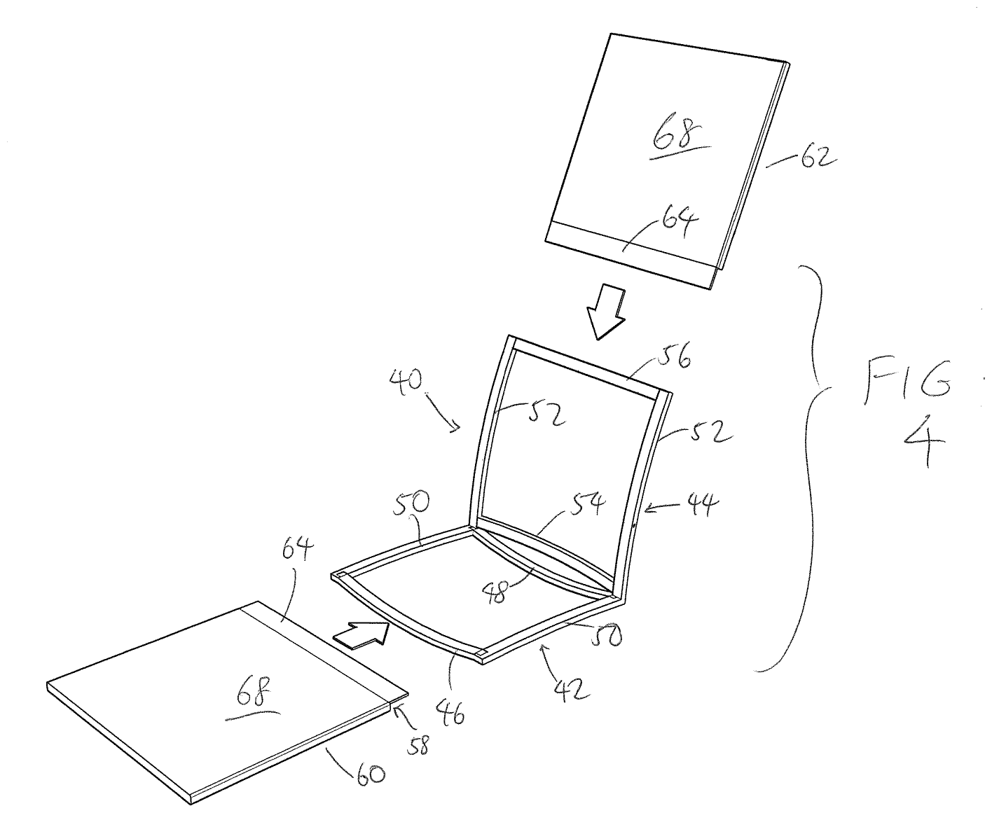

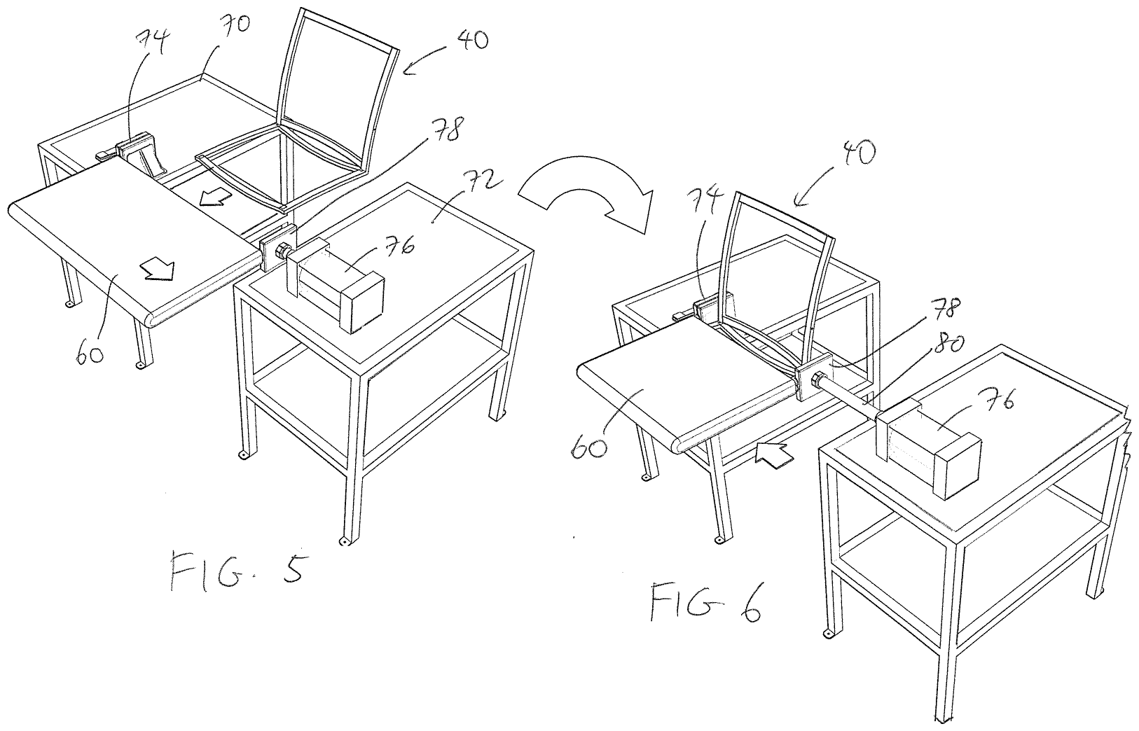

FIGS. 4-7 illustrate a method for making the seat and back portion 14. The seat and back portion 14 is usually provided in three separate pieces: the seat and back frame 40, the seat sock 60 and the back sock 62. A pneumatic spreading machine is provided for use in applying the socks 60 and 62 on to each portion 42, 44. As shown in FIGS. 5-6, the machine includes two spaced-apart tables or stands 70 and 72. The stand 70 has a block 74 with double-bar frame extending forwardly. The double-bar frame is not shown in FIGS. 5 and 6, but it extends into the sock 60. The other stand 72 has a pneumatic actuator 76 secured to the stand, and a block 78 extending from one end of a pneumatic arm 80 that extends from the pneumatic actuator 76. The block 78 also has a double-bar frame extending forwardly; this double-bar frame is not shown in FIGS. 5 and 6, but it extends into the sock 60. The two double bar frames are positioned close to each other so that they can be inserted into the open side 58, and then the pneumatic actuator 76 can be turned on to move the block 78 away from the block 74 (which remains stationary). This will stretch the width of the opening in the open side 58, so that the seat portion 42 can be inserted through the opening of the open side 58. When the seat portion 42 is fully inserted into the sock 60, the pneumatic actuator 76 can be turned on again to move the block 78 towards the block 74. This allows the sock 60 to be compressed on to the seat portion 42, and then the combined sock 60 and seat portion 42 can be removed from the two double-bar frames. The stretchy nature of the fabric material 68 will cause the sock 60 to tightly grip the seat portion 42. The same process can be used to fit the back sock 62 on to the back portion 44. The resulting seat and back portion 14 is shown in FIG. 7.

Next, as shown in FIG. 7, the Velcro™ lips 64 are folded for both the seat sock 60 and the back sock 62. For this step, it is possible and in some cases necessary to provide a custom jig to hold the seat and back frame 40 in place as the Velcro™ lip 64 is brought together because of the tremendous strength needed to wrap the sock 60, 62 over the entire frame 40. This is due to the tremendous tensile strength needed in the fabric material 68 to hold an average adult's weight and also to not sag too much. Finally, bolts 34 are extended through the connector holes 66 in the fabric material 68 and the openings 32 of the bars 26, 28. The chair assembly 10 is now ready for use.

An important benefit provided by the chair assembly 10 of the present invention is that the seat and back section 14 can be replaced while retaining the underlying supporting frame 12. For example, a user may want to replace a worn or defective seat and back section 14, or may desire to have a different color for the fabric material 68. The user can easily separate the supporting frame 12 from the seat and back section 14 by simply removing the bolts 34. A new or different seat and back section 14 can be provided and bolted to the existing supporting frame 12.

In addition, the method of making the seat and back section 14 is simple and advantageous in that the socks 60 and 62 can be easily and effectively fitted in a tight and snug manner over the seat portion 42 and the back portion 44.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A chair assembly, comprising:
a supporting frame made of metal and having four legs and at least two horizontal side bars;
a seat and back section having:
a seat portion and a back portion, the seat portion having a surrounding frame that defines a seat, and the back portion having a surrounding frame that defines a back rest, the surrounding frame of the seat portion having at least two side bars;
a seat sock and a back sock, each sock comprising a fabric material formed into a sock-like configuration having an upper layer and a lower layer, with three sides being sewn or stitched together, and having one open side, and having a Velcro™ lip along the open side;
wherein the back portion is received inside the back sock through the one open side of the back sock, and the seat portion is received inside the seat sock through the one open side of the seat sock; and
wherein each side bar of the seat portion is connected to a separate horizontal side bar of the supporting frame.

2. The assembly of claim 1, wherein each horizontal side bar has a connector, and each side bar of the seat portion is connected to the connector.

3. The assembly of claim 1, wherein the fabric material is made from ultraviolet-enhanced polypropylene and co-polymer fibers.

4. The assembly of claim 3, wherein connector holes are formed in the fabric material.

5. The assembly of claim 1, wherein the Velcro™ lip of each sock is sealed to close the one open side of each sock.

6. A method of making a chair assembly, comprising:
providing a supporting frame made of metal and having four legs and at least two horizontal side bars;
providing a seat and back section having:
a seat portion and a back portion, the seat portion having a surrounding frame that defines a seat, and the back portion having a surrounding frame that defines a back rest, the surrounding frame of the seat portion having at least two side bars;
a seat sock and a back sock, each sock comprising a fabric material formed into a sock-like configuration having an upper layer and a lower layer, with three sides being sewn or stitched together, and having one open side, and having a Velcro™ lip along the open side;
receiving the back portion inside the back sock through the one open side of the back sock;
receiving the seat portion inside the seat sock through the one open side of the seat sock; and
connecting each side bar of the seat portion to a separate horizontal side bar of the supporting frame.

7. The method of claim 6, wherein each horizontal side bar has a connector, further comprising the step of connecting each side bar of the seat portion to the connector.

8. The method of claim 6, wherein the fabric material is made from ultraviolet-enhanced polypropylene and co-polymer fibers.

9. The method of claim 7, further including forming connector holes in the fabric material, and extending bolts through the connector holes and the connector of each horizontal side bar.

10. The method of claim 6, further including sealing the Velcro™ lip of each sock to close the one open side of each sock.

11. The method of claim 6, wherein the receiving steps further include stretching each sock to extend the width of the one open side of each sock.
